(19) United States
(12) Patent Application Publication
(10) Pub. No.: US 2024/0278152 A1
(43) Pub. Date: Aug. 22, 2024

(54) SELF-CLEANING FILTERING DEVICE

(71) Applicant: PLANETCARE D.O.O., Ljubljana (SI)

(72) Inventor: Miha VRHOVEC, Horjul (SI)

(21) Appl. No.: 18/570,368

(22) PCT Filed: May 31, 2022
(86) PCT No.: PCT/EP2022/064680

§ 371 Date: Dec. 14, 2023

(30) Foreign Application Priority Data
Jun. 15, 2021 (DE) 10 2021 115 416.2

(51) Int. Cl. B01D 29/74; B01D 29/15; B01D 29/94

(52) U.S. Cl. CPC B01D 29/74; B01D 29/15; B01D 29/94

(57) ABSTRACT

A filtering device for filtering particles, in particular plastic particles, such as plastic fibers, from liquid is configured to be operated in a filtering mode in which particles, in particular plastic particles, are filtered from a liquid flowing through the filtering device, the filtering device comprising an inlet chamber receiving unfiltered liquid in the filtering mode, an outlet chamber receiving filtered liquid from the inlet chamber in the filtering mode, and a filter screen unit separating the inlet chamber from the outlet chamber and being configured to filter particles from liquid flowing from the inlet chamber into the outlet chamber, wherein the filter screen unit is rotatable about an axis of rotation, characterized in that at least a part of the inlet chamber is located radially outward of the rotatable filter screen unit with respect to the axis of rotation, and the filtering device is configured to be operated in a self-cleaning mode in which the filter screen unit is rotated to detach filtered particle-sludge from the filter screen unit.

### BACKGROUND

### Technical Field

Embodiments of the present invention concern a filtering device for filtering particles, in particular plastic particles, such as plastic fibers, from liquid, as well as a related method.

### Description of the Related Art

There is an increasing need for making the use of liquid filtering devices that filter harmful particles, in particular plastic particles, such as plastic fibers, from particle-contaminated liquids, such as textile washing wastewater, more attractive for users in order to reduce the negative impact of such harmful particles on the environment.

WO 2019/122862 A1 discloses a centrifugal filter unit in which an impeller is rotated to actively draw contaminated liquid axially into the filter unit for filtering the liquid and to expel the filtered liquid in a radial direction.

The removal of captured particle-sludge from such prior art systems, however, is rather cumbersome, often inconvenient, complex and unhygienic, which in particular with regard to a use with domestic appliances leaves room for improvement regarding the ease of use for the end user.

### BRIEF SUMMARY

Some embodiments provide a filtering device as well as a related method that reduces the maintenance efforts normally associated with the use of such particle filtering devices and making the use of such devices more attractive for customers and end users.

Some embodiments relate to a filtering device configured to be operated in a filtering mode in which particles, in particular plastic particles, such as plastic fibers, are filtered from a liquid flowing through the filtering device, the filtering device comprising an inlet chamber receiving unfiltered liquid in the filtering mode, an outlet chamber receiving filtered liquid from the inlet chamber in the filtering mode, and a filter screen unit separating the inlet chamber from the outlet chamber and being configured to filter particles from liquid flowing from the inlet chamber into the outlet chamber, wherein the filter screen unit is rotatable about an axis of rotation.

The filtering device is characterized in that at least a part of the inlet chamber is located radially outward of the rotatable filter screen unit with respect to the axis of rotation, and the filtering device is configured to be operated in a self-cleaning mode in which the filter screen unit is rotated to detach filtered particle-sludge from the filter screen unit.

By locating at least a part of the inlet chamber radially outward of the filter screen unit, the particle-sludge accumulates on the radial outward side, that is, on the inlet chamber side of the rotatable filter screen unit.

This inventive arrangement enables a reliable, centrifugal force-based self-cleaning mode by rotating the filter screen unit until particle-sludge detaches from the outer side of the filter screen unit and is gathered in the inlet chamber, from where it can be transported out of the filtering device, for example through a separate sludge outlet or through an inlet. This enables the removal of the particle-sludge from the filter screen unit with little effort and, for example, in an automated manner and without the need for manually opening the filtering device and removing the particle-sludge.

According to a possible embodiment of the invention, the filtering device is configured to hold the filter screen unit stationary in the filtering mode.

Thus, the filtering device is performing in the filtering mode like a conventional filtering device that only has non-moving parts, and no movement of parts interferes with the flow of liquid through the filtering device or creates undesired noise. Further, a filter cake made of filtered particles/particle-sludge can build on the outer side of the filter screen unit in the filtering mode, which increases the filtering effectiveness.

In a further possible embodiment, the filtering device comprises a first impeller means configured to move liquid from the outlet chamber through the filter screen unit to the inlet chamber, in the self-cleaning mode.

Such an active movement of liquid from the outlet chamber side through the filter screen unit to the inlet chamber side further supports and speeds up the self-cleaning process.

In a possible further advantageous embodiment, a rotation of the first impeller means is coupled to a rotation of the filter screen unit.

This allows a synchronous rotation of the two parts, a design with fewer parts and ensures that both self-cleaning procedures are carried out at the same time.

In a further possible embodiment, the first impeller means is located within the filter screen unit.

This arrangement of the first impeller means within the filter screen unit allows, in an effective and space-saving way, to move liquid from the outlet chamber through the filter screen unit in the self-cleaning mode, and also enables it to actively transport particle-sludge out of the inlet chamber, for example, via a sludge outlet.

In another beneficial possible embodiment, the filtering device comprises a second impeller means configured to remove a suspension comprising particle-sludge from the inlet chamber in the self-cleaning mode.

Such a second impeller means allows the effective removal of the particle-sludge from the inlet chamber and, for example, out of the self-cleaning device in a time-efficient and convenient manner.

In a further possible embodiment, the second impeller means is at least partly located in the inlet chamber.

This enables the removal of the particle-sludge from the inlet chamber in an effective manner.

In another embodiment, it is possible that a rotation of the second impeller means is coupled to a rotation of the filter screen unit, and/or that a rotation of the second impeller means is coupled to a rotation of the first impeller means.

Such couplings allow the rotation of the coupled parts at the same time in an efficient manner.

In a further beneficial possible embodiment, the filter screen unit and the first impeller means are driven by a common drive shaft extending along the axis of rotation.

This enables an efficient driving of the filter screen unit and the first impeller means, while realizing a compact design for the filtering device.

In a further advantageous, possible embodiment, the second impeller means is driven by the drive shaft.

This enables an efficient driving of all moving parts during in the self-cleaning mode, while maintaining a compact filter device design.

It is further possible that in another embodiment, the axis of rotation runs through a part of the outlet passageway of the outlet chamber and/or the drive shaft runs through a part of the outlet passageway of the outlet chamber.

Such arrangements move the position of the required sealing between a central driving means, such as the drive shaft, and the filter device housing to a more protected area of the filtering device, where there is comparably little liquid motion/pressure applied to the seal during the rotation in the self-cleaning mode.

In another possible embodiment, the filter screen unit comprises a hollow cage-like structure, the outlet chamber is located within the filter screen unit, and the filter screen unit is surrounded by the inlet chamber.

This nested arrangement allows for a very compact and space-saving design of the filtering device.

In a further advantageous, possible embodiment, the inlet chamber comprises a separate sludge outlet allowing particle-sludge to exit the filtering device in the self-cleaning mode.

This enables a convenient and clean disposal of the particle-sludge to downstream particle-sludge disposal means without interfering with the inlet and outlet of the chambers.

In a preferred, possible embodiment, there is a direct liquid flow path between the second impeller means and the sludge outlet.

This arrangement ensures an efficient transport of particle-sludge out of the filtering device.

In another possible embodiment, the second impeller means seals off a sludge outlet from the inlet chamber in the filtering mode.

This is an efficient way to control the flow of liquid through the sludge outlet and, for example, to prevent that liquid exiting the inlet chamber through the sludge outlet in the filtering mode.

In yet another possible embodiment, the filtering device comprises a detachable particle-sludge collecting means for capturing and dewatering particle-sludge detached from the filter screen unit in the self-cleaning mode.

This allows the gathering and concentration of the filtered particle-sludge in the filtering device itself and to conveniently clean or replace the particle-sludge collecting means by detaching and re-attaching it to the filtering device.

In a further possible embodiment, the particle-sludge collecting means is provided in the form of a second filter screen unit that is rotatable around the axis of rotation.

This allows the dewatering of the captured particle-sludge by centrifugal forces when rotating the second filter screen unit.

An optional rotating of the second filter screen unit by the common drive axis allows for a compact design and ensures that the second filter screen unit is rotated at the same time as, for example, the filter screen unit, the first impeller means and/or the second impeller means.

According to another possible embodiment, the particle-sludge collecting means is positioned in the flow path from the filter screen unit to the sludge outlet.

This ensures that particles are captured before liquid exits the sludge outlet in the self-cleaning mode.

In another possible embodiment of the invention, the inlet of the inlet chamber and the outlet of the outlet chamber are both located on the same axial face side of the filtering device.

Locating the inlet and outlet on the same axial face side focuses the required piping to a single side of the filtering device.

Optionally, when there is a separate sludge outlet, the inlet and outlet are located at an opposing end of the filtering device with respect to the sludge outlet, which allows for advantageous concentration of the accumulation of particle-sludge at the sludge outlet location by installing the filtering device in a certain orientation e.g. in a vertical orientation of the axis of rotation with the inlet and outlet oriented to the top side and the sludge outlet oriented to the bottom side.

A further possible embodiment of the invention relates to a filtering system comprising a filtering device according to one of the preceding embodiments, a detecting and control unit for detecting directly or indirectly a level of clogging of the filter screen unit, and a motor unit drivingly coupled with the filter screen unit and connected to the detecting and control unit, wherein the detecting and control unit is configured to execute the self-cleaning mode dependent on a detected level of clogging.

This system ensures a long-lasting operation readiness of the filtering device without the need for manual maintenance of the filtering device.

Another possible embodiment of the invention relates to a machine producing a flow of particle-contaminated liquid, in particular a textile washing machine, comprising a filtering device according to one of the preceding embodiments or a filtering system according to the previously described embodiment, in particular comprising said filtering device or said filtering system installed within the machine body casing.

Providing a contaminated-liquid producing machine, in particular a textile washing machine, with a filtering device or a filtering system according to the previous embodiments, enables a reliable filtering of the contaminated liquids at the source. The filtering device or filtering system optionally being installed within the machine body casing allows for non-interference with the optical appearance of the machine while still providing the full filtering and benefits of the present invention to the customer or end user.

In a possible embodiment, the machine comprises a particle-sludge collecting means for capturing and dewatering detached particle-sludge, in particular accessible from outside of the machine, more particularly implemented in an accessible opening of the machine, such as in a drawer of the machine, wherein the filtering device is connected to the particle-sludge collecting means such that filtered particle-sludge can be transported into the particle-sludge collecting means.

Providing such a particle-sludge collecting means allows for capturing and dewatering particle-sludge in the self-cleaning mode. Optionally, the particle-sludge may be collected at a defined location of the machine that is easily accessible from the outside of the machine for the user. Optionally implementing the particle-sludge collecting means in a readily accessible opening of the machine, such as a drawer of the machine, allows for an easy access to the collecting means that can be hidden from view when not required. Further, in case of a textile washing machine, the collecting means can be implemented into a drawer that is required in any case for the detergents.

Some embodiments provide a method of operating a filtering device filtering particles, in particular filtering plastic particles, such as plastic fibers, from a flow of liquid, the method comprising the steps of directing, in a filtering mode, a flow of liquid from the exterior of a rotatable filter screen unit through the rotatable filter screen unit and to the interior of the filter screen unit and thereby accumulating filtered particle-sludge on the radial outer side of the filter screen unit, and rotating the filter screen unit to detach filtered particle-sludge from the filter screen unit in a self-cleaning mode.

This method extends the service life of the filtering device and strongly reduces maintenance efforts.

In a possible and advantageous embodiment, the method comprises executing the self-cleaning mode dependent on a level of clogging of the filter screen unit.

Thus, the self-cleaning mode of the filter screen unit is carried out when required.

In another possible embodiment, the method comprises actively transporting liquid from the interior of the filter screen unit through the filter screen unit to the exterior of the filter screen unit, in the self-cleaning mode.

This further supports and speeds up the self-cleaning process.

In yet another possible embodiment, the method further comprises actively transporting in the self-cleaning mode a suspension comprising detached particle-sludge to a particle-sludge collecting means for capturing and dewatering the particle-sludge, in particular to a particle sludge collecting means detachable from the filtering device or to a particle-sludge collecting means external to the filtering device, such as to a compartment of a textile washing machine.

Actively transporting a suspension comprising detached particle-sludge to a particle-sludge collecting means for capturing and dewatering the particle sludge in the self-cleaning mode, for example by an impeller means, allows removal of the concentrated particle-sludge from the filtering device in a time-efficient and convenient manner, in particular of the particle-sludge is captured in an aforementioned detachable collecting means or external collecting means.

In advantageous possible embodiments, the aforementioned methods are carried out with a filtering device according to one of the previously mentioned embodiments, or are carried out with a filtering system as previously mentioned, or are carried out with a machine according to one of the previously mentioned embodiments.

In possible further embodiments, the aforementioned self-cleaning mode can be carried out for a time period in the range from 5 seconds to 10 seconds and with a speed in the range from 500 rpm to 3500 rpm.

In possible further embodiments, it is actively controlled, for the herein disclosed embodiments, whether the inlet, the outlet, and the sludge outlet are opened or closed, dependent on whether the filtering device is operated in the filtering mode or the self-cleaning mode.

In further embodiments of the aforementioned embodiments, the filter screen unit can be manufactured from metal and/or plastic, and/or can have a perforation with aperture sizes in the range from 20 μm to 200 μm.

In possible further embodiments of the aforementioned embodiments, the filtering device is operating while being under internal liquid pressure in the filtering mode and/or in the self-cleaning mode.

### BRIEF DESCRIPTION OF THE SEVERAL VIEWS OF THE DRAWINGS

In order to improve the understanding of the invention, possible embodiments of the invention constituting combinations of various aforementioned embodiments will now be described with reference to the following figures:

FIG. 1 shows a perspective view of a schematically illustrated filtering device according to an embodiment of the invention as well as a schematically illustrated motor unit drivingly coupled thereto,

FIG. 2 shows the arrangement of FIG. 1 in an exploded view,

FIG. 3 shows a cross-sectional view through FIG. 1 taken along the axis of rotation, with the filtering device in the filtering mode (the blades of a first impeller means are not illustrated here for the purpose of better illustration),

FIG. 4 shows a cross-sectional view according to FIG. 3 with the filtering device in the self-cleaning mode (the blades of the first impeller means are not illustrated here for the purpose of better illustration),

FIG. 5 shows a cross-sectional view through the filtering device in the self-cleaning mode taken along the line B-B in FIG. 4 (the sludge outlet is not illustrated in this view for reasons of simplicity),

FIG. 6 shows a horizontal cross-sectional view through the filtering device in the self-cleaning mode, taken along line C-C in FIG. 4, at the second impeller means,

FIG. 7 shows a cross-sectional view through another embodiment of a filtering device having a second impeller means comprising flexible vanes, cut at a similar location as FIG. 6,

FIG. 8 shows a schematically illustrated filtering device according to an embodiment of the present invention implemented in a schematically illustrated textile washing machine,

FIG. 9 shows a cross-sectional view taken along axis A of another schematically illustrated embodiment of a filtering device according to the invention.

### DETAILED DESCRIPTION

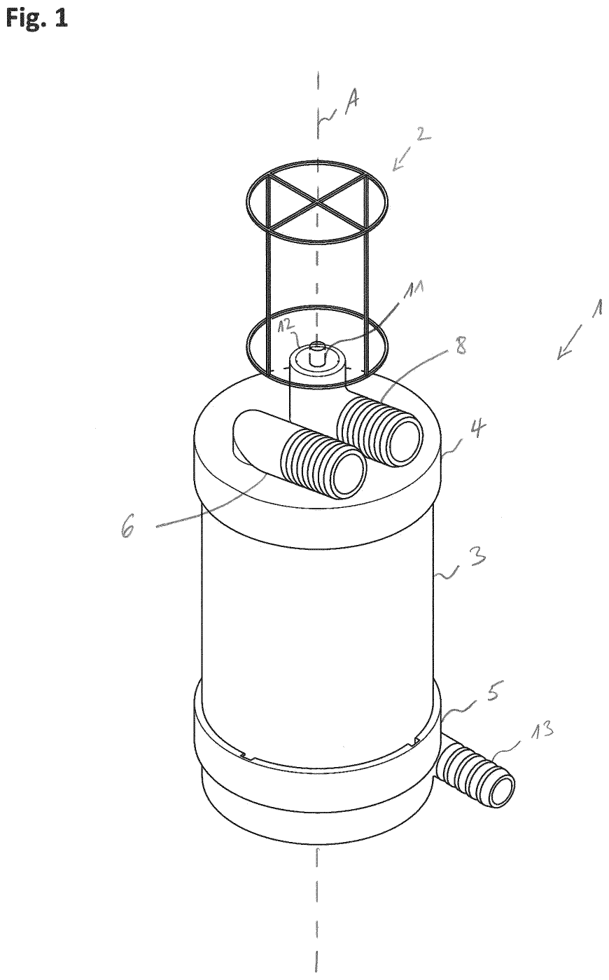

FIG. 1 shows a filtering device 1 according to the present invention and a schematically illustrated motor unit 2 drivingly coupled to the filtering device 1.

The filtering device 1 extends along an axis of rotation A with a cylindrically shaped main body casing 3 and basically flat and also cylindrically shaped end caps 4, 5, liquid-tight and removably attached to the opposite ends of the main body casing 3.

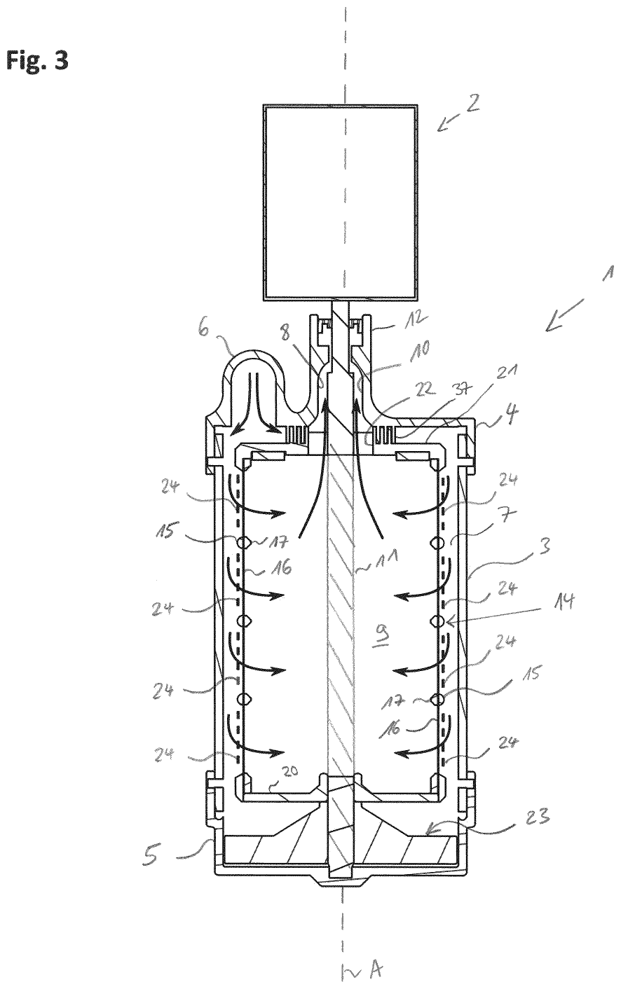

The end cap 4 at the motor-side end of the filtering device 1 comprises an inlet 6 in fluid communication with an inlet chamber 7 within the filtering device 1 (see e.g. FIG. 3) and comprises an outlet 8 in fluid communication with an outlet chamber 9 within the filtering device 1 (see e.g. FIG. 3).

The outlet 8 has a nozzle-like shape that can be connected to a hose e.g. leading to a sewer system or the like. The inlet 6 has a nozzle-like shape and can be connected to a hose which in turn is connected with the waste water outlet or pump of a machine producing a particle contaminated liquid, such as a textile washing machine that normally discontinuously pumps out fiber contaminated waste water during operation.

The outlet 8 protrudes from the motor-side end cap 4 such that the axis of rotation A runs through a part of the passageway 10 of the outlet 8 (see FIG. 3).

A drive shaft 11 extends along the axis A through the filtering device 1. The drive shaft 11 extends through the passageway 10 of the outlet 8 and through the outer wall 12 of the outlet 8 in a sealed manner, such that it reaches into the motor unit 2, as can be seen e.g. in FIG. 3.

At the opposite, non-motor side end cap 5, there is a sludge outlet 13 located on a tangential outer side of the end cap 5. The sludge outlet 13 also has a nozzle-like shape and can be connected to a hose, which in turn can be in fluid communication with a particle-sludge collecting means, for example located in a drawer of a textile washing machine.

Both outlets 8, 13 as well as the inlet 6 point into the same direction and are oriented approximately perpendicular to the axis of rotation A.

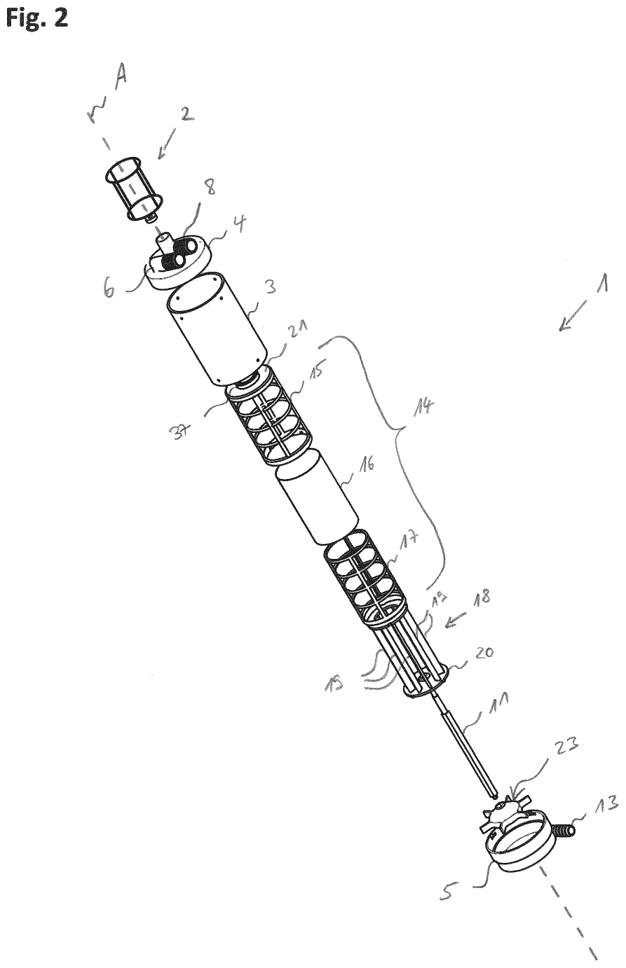

In the exploded view of FIG. 2, one can see the inner structure and functioning of the filtering device 1.

As can be seen from FIG. 2, the filtering device 1 further comprises a rotatable filter screen unit 14 that in this embodiment comprises a radially outer, lattice-like support frame 15 having a hollow cylindrical shape, a liquid permeable filter screen sheet 16 having a hollow cylindrical shape, and a radially inner lattice-like support frame 17. The filter screen sheet 16 is clamped between the two support frames 15, 17. In further possible embodiments, the filter screen sheet 16 is self-supporting and does not require the two support frames 15, 17. In another possible embodiment the filter screen sheet 16 is only supported by an inner support frame.

The filter screen unit 14 separates the radially outer inlet chamber 7 from the radially inward outlet chamber 9 and forms the barrier between the two chambers. Here in this embodiment, the outlet chamber 9 is located within the hollow filter screen unit 14 and the filter screen unit 14 in turn is surrounded by the inlet chamber 7.

Within the filter screen unit 14 there is located a first impeller means 18 that in this embodiment contains several liquid-moving impeller-blades 19 that longitudinally extend from a circular shaped end plate 20 along the axis of rotation and are arranged along a circular path around the axis of rotation A. The end plate 20 of the first impeller mean 18 is located at the non-motor end side of the filter screen unit 14. In this embodiment, the first impeller means 18 is rotationally coupled with the filter screen unit 14 via the end plate 20 being in a form fit with the inner support frame 17.

At the motor-end side of the filter screen unit 14, there is another end plate 21 closing the filter screen unit 14 at this end and having an axial passageway 22 that establishes via a ring-shaped outlet seal 37, e.g. a labyrinth seal, a fluid connection with the outlet passageway 10, as can best be seen in FIG. 3.

The drive shaft 11 extends from the motor unit 2 along the axis of rotation A and through the filter screen unit 14 and the first impeller means 18 and ends at a second impeller means 23 to which it is drivingly coupled as well being drivingly coupled to the first impeller means 18.

The second impeller means 23 is located at the location of the non-motor end cap 5 of the filtering device 1 in the proximity of the sludge outlet 13. In this embodiment, the second impeller means has rigid vanes 40, preferably made of a polymeric material. In this embodiment of the filtering device, the sludge outlet 13 is positioned tangentially to the direction of rotation of the second impeller means 23. Further, in this embodiment a direct liquid flow path is established between the second impeller means 23 and the sludge outlet 13.

The cross-sectional view of FIG. 3 shows the filtering device 1 in the filtering mode. The arrows indicate the flow direction of the liquid. The blades 19 of the first impeller means 18 are not illustrated in this figure for reasons of simplicity. The motor unit 2 holds the drive shaft 11 stationary, that is, during the filtering mode no parts of the filtering device 1 are moving.

In the depicted filtering mode of FIG. 3, particle-contaminated liquid, for example textile washing water contaminated with plastic fibers coming from a textile washing machine 25, enters the inlet chamber 7 via the inlet 6 and flows through the cylindrical walls of the filter screen unit 14, more specifically though the cylindrical filter screen sheet 16, and into the outlet chamber 9 and on through the outlet passageway 10 and exiting the outlet 8 and e.g. on into the drain. In the filtering mode, particle-sludge 24 filtered from the liquid accumulates on the radial outer side of the filter screen unit 14, more specifically here on the radial outer side of the filter screen sheet 16.

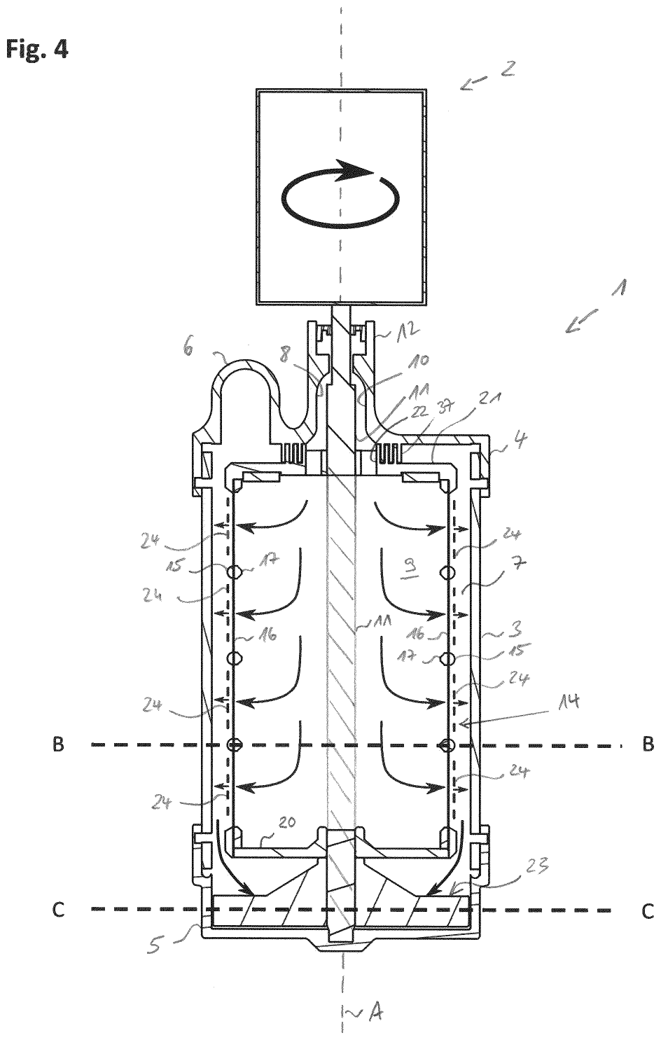

The cross-sectional view of FIG. 4 shows the filtering device 1 in the self-cleaning mode in which, in this embodiment, the motor unit 2 simultaneously rotates the filter screen unit 14, the first impeller means 18, and the second impeller means 23 by the drive shaft 11 in the same direction of rotation. The arrows in the filtering device indicate the flow direction of the liquid. The blades 19 are not illustrated in this figure for reasons of simplicity.

As can be seen, due to the centrifugal force initiated by the rotation of the filter screen unit 14 and enhanced by the radial flow of liquid from the outlet chamber 9 through the walls of the filter screen unit 14 propelled by the first impeller means 18 into the inlet chamber 7, the particle-sludge 24 detaches from the radial outer side of the filter screen sheet 16 into the inlet chamber 7, and is transported through the sludge outlet 13 by the second impeller means 23.

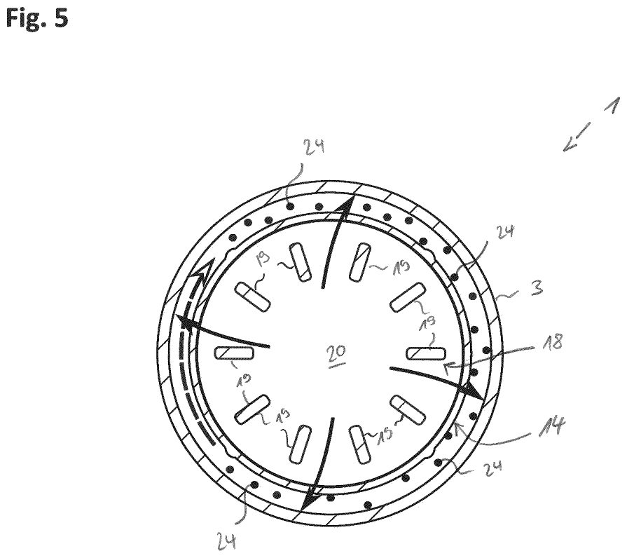

The cross-sectional view of FIG. 5 shows the filtering device 1 in the state of FIG. 4 cut along line B-B. The sludge outlet 13 is not illustrated in this view for reasons of simplicity. The solid line arrows in the filtering device 1 indicate the flow direction of the liquid. The broken line arrow shows the direction of rotation of the filter screen unit 14 and the first impeller means 18 (comprising the blades 19). The filter screen unit 14 is depicted in this figure as a single part for reasons of simplicity.

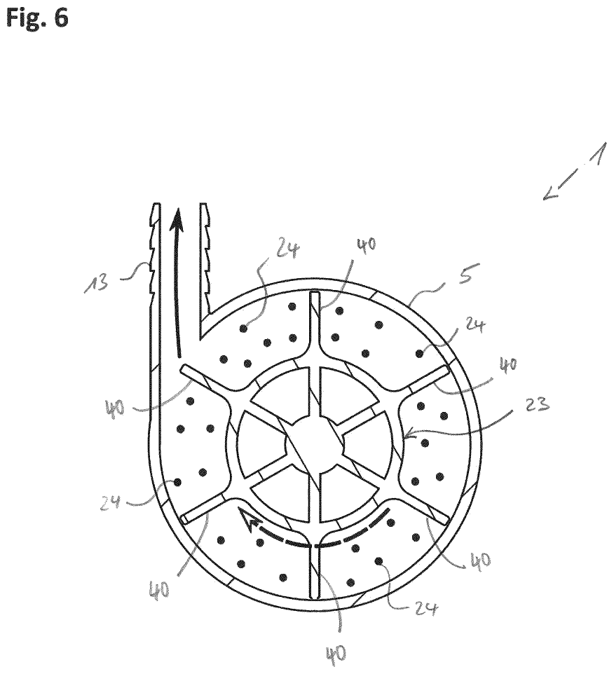

The cross-sectional view of FIG. 6 shows the filtering device 1 in the state of FIG. 4 cut along line C-C. As can be seen, the rotating second impeller means 23 actively transports the water suspension comprising particle-sludge 24, here the plastic fibers, out of the sludge outlet 13.

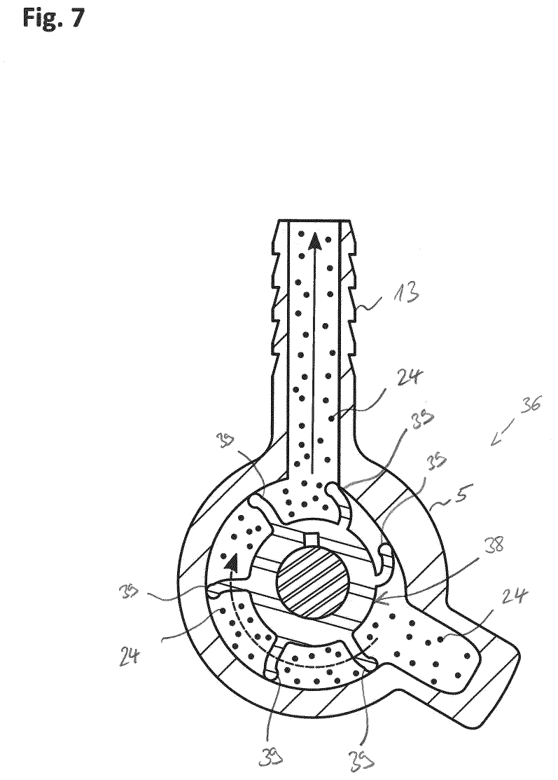

FIG. 7 shows a cross sectional view in the style of FIG. 6 through a further embodiment of a filtering device 1. The filtering device 36 comprises similar features having similar functions to filtering device 1. Similar features have been provided with the same reference numbers.

The filtering device 36 basically only distinguishes from filtering device 1 in the second impeller means 38 that comprises flexible vanes 39, such that the flexible vanes 39 sealingly press against the inner wall of the end cap 5, while the second impeller means 36 is stationary. The flexible vanes 39 are configured such that they can seal off the inlet chamber 7 from the sludge outlet 13 during the filtering mode. In an embodiment, the flexible vanes 39 are manufactured at least partially from a rubber-based material.

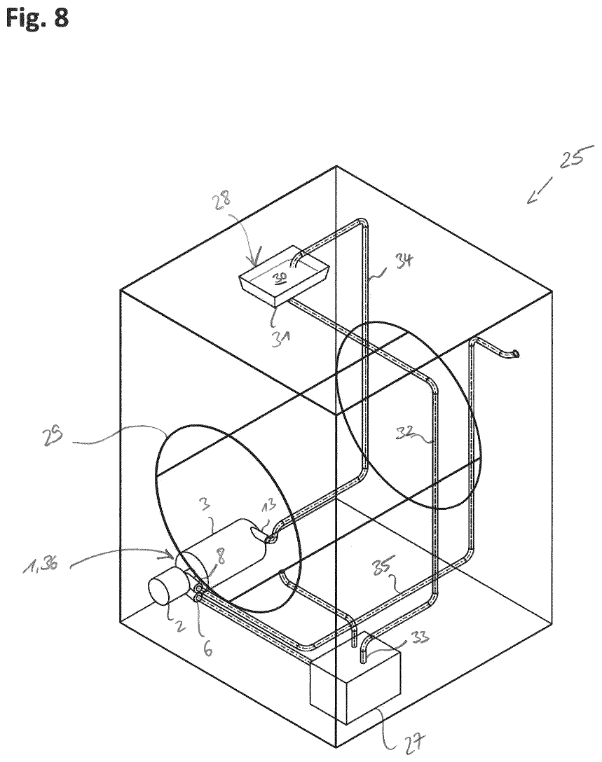

FIG. 8 schematically shows a machine 25 producing particle-contaminated liquid, here a textile washing machine, from the front and lateral side with the machine body casing 26 changed to transparent to allow a view into the interior of the machine 25.

The machine 25 comprises the filtering device 1 or alternatively the filtering device 36 according to the previously described embodiments.

FIG. 8 shall be interpreted as disclosing an advantageous and exemplary implementation of embodiments of filtering devices 1, 36 into a machine producing a flow of particle-contaminated liquid, in particular of a textile washing machine producing a flow of plastic-fiber contaminated water.

The filtering device 1, 36 including its driving motor unit 2 are installed in the interior of the machine 25, as is a machine drain pump 27, a particle-sludge collecting means 28—here in the form of a compartment in the detergent drawer of the washing machine 25—and a washing drum 29.

The machine 25 further comprises a detecting and control unit (not depicted) for detecting directly or indirectly a level of clogging of the filter screen unit 14 with particles. The detecting and control unit can for example comprise one pressure sensor at the inlet 6, a washing water level detector in the washing drum 29, or a water flow detector e.g. located at the outlet 8. The detecting and control unit is in communication with the motor unit 2 and can initiate a self-cleaning routine based on a detected level of clogging of the filter screen unit 14, or here of the filter screen sheet 16.

For example, if excessive clogging is detected, as the machine drain pump could be stopped, a self-cleaning of the filtering device 1, 36 initiated and then the drain pump 27 resumed. The procedure would, for example, take within the range from 2 to 10 seconds.

The washing drum 29 is in fluid connection with the inlet of the filtering device 1, 36 via the machine drain pump 27. The outlet of the filtering device 1, 36 is in fluid connection with a sewer pipe, and the sludge outlet of the filtering device 1, 36 is in fluid connection with the particle-sludge collecting compartment 28 in the drawer.

The particle-sludge collecting compartment 28 is connected to the sludge outlet via a sludge hose 34 and can comprise a strainer 30 on top of a collecting cup 31 that is connected by a hose 32 to the inlet 33 of the drain pump 27.

The strainer 30 is configured to capture the particles, or here plastic fibers, and to dewater the particle-sludge by gravity, such that the concentrated particles, here plastic fibers, can for example later be conveniently removed by a user from the drawer compartment 28. As can further be seen from FIG. 8, the outlet of the filtering device 1, 36 is fluidly connected by a drain hose 35 to a sewer pipe.

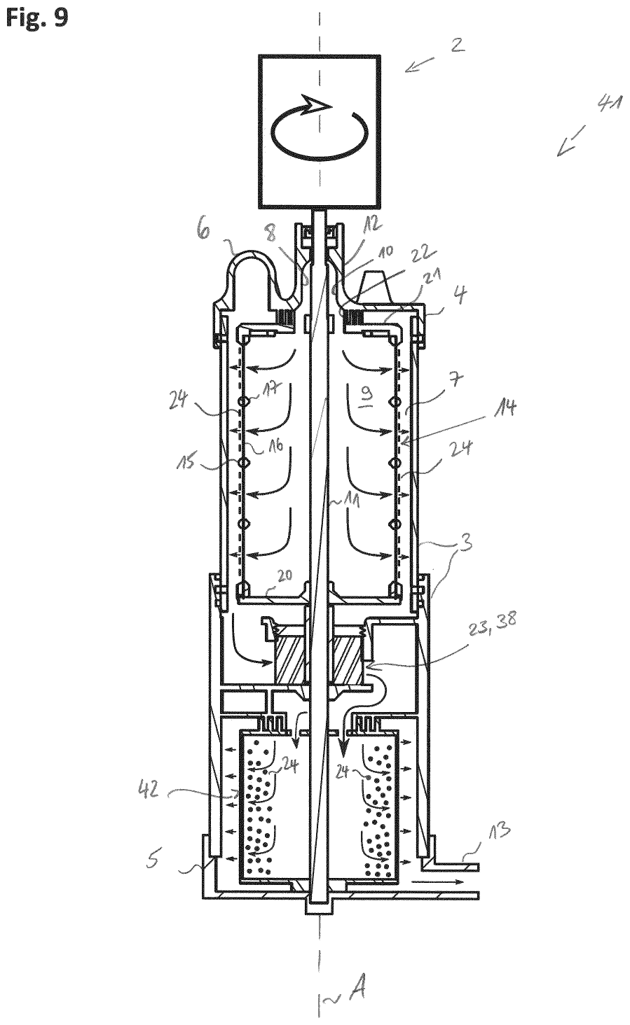

FIG. 9 shows a cross-sectional view through a filtering device 41 of another embodiment according to the present invention.

The filtering device 41 comprises similar features having similar functions to filtering devices 1 and 36. Similar features have been provided with the same reference numbers. The first impeller means 18 (that is, here the vanes 19) of the previous embodiments is also present in this embodiment although not illustrated in FIG. 9 for reasons of clarity.

The filtering device 41 basically only distinguishes from the filtering devices 1 and 36 in the lower half of the device that in this embodiment faces away from the motor unit 2.

The main body casing 3 in this embodiment comprises two parts, more specifically two fluid-tight connected hollow and cylindrical casings, wherein the end cap 5 with the sludge outlet 13 closes the lower open end of the main body casing 3 in a removable, but fluid tight manner.

The present filtering device 41 contains in its middle section a second impeller means according to the ‘sealing-off’-second impeller means 38 as described in connection with filtering device 36 or, alternatively, the second impeller means 23 as described in connection with filtering device 1.

The lower half of the filtering device 41 comprises a detachable particle-sludge collecting means for capturing and dewatering particle-sludge coming from the filter screen unit 14 in the self-cleaning mode. In this embodiment, the detachable particle-sludge collecting means is embodied by a rotatable second filter screen unit 42 having a mesh and a hollow basket-like construction quite similar to the filter screen unit 14.

The filtering device 41 comprises the filter screen unit 14, the second impeller means 38 (or alternatively the means 23) and the detachable particle-sludge collecting means, here in the form of the second filter screen unit 42, along the axis of rotation A in the order as stated.

FIG. 9 shows the filtering device 41 in the self-cleaning mode. As illustrated by the arrows in this figure, in the self-cleaning mode, a suspension of liquid comprising particle-sludge detached from the filter screen unit 14 is actively transported via the second impeller means 38 (or 23) into the second filter screen unit 42, where particles are captured and the particle-sludge is dewatered, here by centrifugal forces coming from the rotation of the filter screen unit 42 in combination with the mesh of the second filter screen unit 42.

The second filter screen unit 42 is detachable from and re-attachable to the filtering device 41, for example via friction fit and the use of fitting seals. In this embodiment, this also applies for the end cap 5.

In the self-cleaning mode, the second filter screen unit 42 captures and dewaters the particle-sludge such that only filtered liquid exits the sludge outlet 13, which can for example be connected to a sewer pipe.

In some embodiments, the filtering device 41 is installed together with the motor unit 2 and the aforementioned detecting and control unit (not illustrated) within the machine body casing 26 of a machine producing contaminated liquid to be filtered, for example the textile washing machine 25. In such a case, the filtering device 41 would be installed in such a manner that the lower half containing the detachable particle-sludge collecting means, in the present embodiment the second filter screen unit 42, would still be accessible by a user from the outside of the machine 25, for example hidden behind a removable cover or door of the machine 25.

In other embodiments, the filtering device 41 can be attached to the outer periphery of a machine 25.

In the following, the functioning of the illustrated embodiments will be briefly explained.

When the filtering device 1, 36, 41 is in the filtering mode, particle-contaminated liquid coming e.g. from the washing machine 25 enters the inlet chamber 7 via the inlet 6 and flows through the filter screen sheet 16 radially inward into the outlet chamber 9, and from the outlet chamber 9 though the outlet 8 into the sewer system. The rotatable filter screen unit 14 is kept stationary by motor unit 2 and does not rotate. In the filtering mode, contaminant particles, here plastic fibers, are accumulated on the radial outer side of the filter screen sheet 16 and with time will start to increasingly reduce the possible volume flow of liquid through filter screen unit 14 and thus from inlet chamber 7 into outlet chamber 9. In case of filtering device 36, the flexible vanes 39 of the second impeller means 38 seal off the sludge outlet 13 from the inlet chamber 7 and thus prevents liquid to be filtered from exiting the filtering device through the sludge outlet 13 in an efficient way.

The detecting and control unit can monitor the state of clogging of the filter screen unit 14 by the accumulated particles, e.g. by a pressure sensor at the inlet 6, and in case the detected pressure exceeds a threshold value, will communicate to the motor unit 2 to initiate a self-cleaning mode routine in which the filter screen unit 14 as well as the first impeller means 18 and, if present, the second impeller means 23 or 38 are rotated, e.g. at 1000 rpm, for a certain time period, e.g. 7 seconds, to detach the particle-sludge 24 from the filter screen unit 14 by centrifugal force as well as by residual liquid flowing from the outlet chamber 9 radially outward through the filter screen sheet 16 into the inlet chamber 7.

In the case of filtering devices 1 and 36, particle-sludge 24 is actively transported in a suspension with water by the rotation of the first 18 and/or second impeller means 23 or 38 through the sludge outlet 13 to the sludge-collecting means 28, here located in the front drawer of the machine 25, where it is captured and dewatered and the end user/customer can easily access the concentrated particles, here plastic fibers, for an environment-friendly disposal with little effort.

In the case of filtering device 41, the particle-sludge 24 is actively transported in a suspension with water by the first 18 and/or second impeller means 23 or 28 to the second filter screen unit 42, where it is captured and dewatered by centrifugal forces applied through the rotating of the second filter screen unit 42 together with shaft 11. The user can then, preferably after several self-cleaning cycles have passed, detach the end cap 5 from the device 41, clean or replace the second filter screen unit 42 and reattach everything into place for making the filtering device ready for continues use.

1. A filtering device configured to be operated in a filtering mode in which particles are filtered from a liquid flowing through the filtering device, the filtering device comprising:
an inlet chamber receiving unfiltered liquid in the filtering mode,
an outlet chamber receiving filtered liquid from the inlet chamber in the filtering mode, and
a filter screen unit separating the inlet chamber from the outlet chamber and being configured to filter particles from liquid flowing from the inlet chamber into the outlet chamber,
wherein the filter screen unit is rotatable about an axis of rotation,
wherein at least a part of the inlet chamber is located radially outward of the rotatable filter screen unit with respect to the axis of rotation, and
wherein the filtering device is configured to be operated in a self-cleaning mode in which the filter screen unit is rotated to detach filtered particle-sludge from the filter screen unit.

2. A filtering device according to claim 1, wherein the filtering device is configured to hold the filter screen unit stationary in the filtering mode.

3. A filtering device according to claim 1, further comprising a first impeller configured to move liquid from the outlet chamber through the filter screen unit to the inlet chamber, in the self-cleaning mode.

4. A filtering device according to claim 3, wherein a rotation of the first impeller is coupled to a rotation of the filter screen unit.

5. A filtering device according claim 3, wherein the first impeller is located within the filter screen unit.

6. A filtering device according to claim 1, further comprising:
a second impeller configured to remove a suspension comprising particle-sludge from the inlet chamber in the self-cleaning mode.

7. A filtering device according to claim 6, wherein the second impeller is at least partly located in the inlet chamber.

8. A filtering device according to claim 6, wherein a rotation of the second impeller is coupled to a rotation of the filter screen unit, and/or, a rotation of the second impeller is coupled to a rotation of the first impeller.

9. A filtering device according to claim 6, wherein the filter screen unit and the first impeller are driven by a common drive shaft extending along the axis of rotation.

10. A filtering device according to claim 9, wherein the second impeller is driven by the drive shaft.

11. A filtering device according to claim 9, wherein the axis of rotation runs through a part of the outlet passageway of the outlet chamber and/or, the drive shaft runs through a part of the outlet passageway of the outlet chamber.

12. A filtering device according to claim 1, wherein:
the filter screen unit comprises a hollow cage-like structure,
the outlet chamber is located within the filter screen unit, and
the filter screen unit is surrounded by the inlet chamber.

13. A filtering device according to claim 9, wherein the inlet chamber comprises a separate sludge outlet allowing particle-sludge to exit the filtering device in the self-cleaning mode.

14. A filtering device according to claim 13, wherein there is a direct liquid flow path between the second impeller and the sludge outlet.

15. A filtering device according to claim 13, wherein the second impeller seals off the sludge outlet from the inlet chamber in the filtering mode.

16. A filtering device according to claim 13, comprising a detachable particle-sludge collecting unit for capturing and dewatering particle-sludge detached from the filter screen unit in the self-cleaning mode.

17. A filtering device according to claim 16, wherein the particle-sludge collecting unit is provided in the form of a second filter screen unit rotatable around the axis of rotation, wherein the second filter screen unit is driven by the common drive shaft in the self-cleaning mode.

18. A filtering device according to claim 16, wherein particle-sludge collecting unit is positioned in the flow path from the filter screen unit to the sludge outlet.

19. A filtering device according to claim 13, wherein the inlet of the inlet chamber and the outlet of the outlet chamber are both located on the same axial face side of the filtering device, wherein the inlet and outlet are located at an opposing axial face side of the filtering device with respect to the sludge outlet.

20. A filtering system, comprising:
a filtering device according to claim 1,
a detecting and control unit for detecting directly or indirectly a level of clogging of the filter screen unit, and
a motor unit drivingly coupled with the filter screen unit for rotating the filter screen unit and connected to the detecting and control unit, wherein the detecting and control unit is configured to execute the self-cleaning mode dependent on a detected level of clogging.

21. A machine producing a flow of particle-contaminated liquid, in particular a textile washing machine, comprising a filtering device according to claim 1, wherein said filtering device is installed within the machine body casing.

22. A machine according to claim 21, further comprising:
a particle-sludge collecting unit for capturing and dewatering detached particle-sludge, accessible from outside of the machine, implemented in an accessible opening of the machine, in a drawer of the machine, wherein the filtering device is connected to the particle-sludge collecting unit such that filtered particle-sludge can be transported into the particle-sludge collecting unit.

23. A method of operating a filtering device filtering particles from a flow of liquid, the method comprising:
directing, in a filtering mode, a flow of liquid from the exterior of a rotatable filter screen unit through the rotatable filter screen unit to the interior of the filter screen unit and thereby accumulating filtered particle-sludge on the radial outer side of the filter screen unit, and
rotating the filter screen unit to detach filtered particle-sludge from the filter screen unit in a self-cleaning mode.

24. A method according to claim 23, comprising executing the self-cleaning mode dependent on a level of clogging of the filter screen unit.

25. A method according to claim 23, comprising actively transporting liquid from the interior of the filter screen unit though the filter screen unit to the exterior of the filter screen unit, in the self-cleaning mode.

26. A method according to claim 23, comprising actively transporting in the self-cleaning mode a suspension comprising detached particle-sludge to a particle-sludge collecting unit for capturing and dewatering the particle-sludge, in particular to a particle-sludge collecting unit detachable from the filtering device or to a particle-sludge collecting means unit external to the filtering device such as to a compartment of a textile washing machine.

27. (canceled)
